(19) United States
(12) Patent Application Publication
(10) Pub. No.: US 2026/0058538 A1
(43) Pub. Date: Feb. 26, 2026

(54) POWER CONVERSION DEVICE

(71) Applicant: Panasonic Intellectual Property Management Co., Ltd., Osaka (JP)

(72) Inventors: Sho HIURA, Osaka (JP); Ryusuke KANOMATA, Osaka (JP); Shinji UJITA, Osaka (JP); Kenichiro TANAKA, Hyogo (JP)

(21) Appl. No.: 19/104,977

(22) PCT Filed: Jun. 19, 2023
(86) PCT No.: PCT/JP2023/022563

§ 371 Date: Feb. 19, 2025

(30) Foreign Application Priority Data
Sep. 2, 2022 (JP) 2022-139983

(51) Int. Cl. H02M 1/00; H02M 1/16

(52) U.S. Cl. CPC H02M 1/0058; H02M 1/0009; H02M 1/16

(57) ABSTRACT

A power conversion device includes: a first switch; a second switch; a first inductor; a first current sensor circuit that detects an electric current flowing to the first inductor; and a first resonant period detection circuit that detects a resonant period of a first resonance phenomenon that occurs by switching operations of the first switch and the second switch. The first resonance phenomenon occurs due to energy that has accumulated in the first inductor in a first energy application period. The first resonant period detection circuit detects the resonant period of the first resonance phenomenon based on the result of comparison between a reference voltage and a voltage generated from a resonance current flowing to the first inductor due to the first resonance phenomenon and detected by the first current sensor circuit.

### TECHNICAL FIELD

The present disclosure relates to power conversion devices.

### BACKGROUND ART

Patent Literature (PTL) 1 discloses a power conversion device that measures a resonant period required for what is called zero voltage switching (ZVS).

### CITATION LIST

### Patent Literature

[PTL 1] Japanese Patent No. 6711123

### SUMMARY OF INVENTION

### Technical Problem

In the power conversion device disclosed in PTL 1, a voltage at each end of an inductor is detected during the measurement of a resonant period. In this case, a circuit that detects voltages at two places is required, resulting in an increase in circuit size. Furthermore, the voltages at the inductor vary significantly, meaning that noise is likely to be superimposed during the detection of a resonant period.

In view of this, the present disclosure provides a power conversion device that is capable of reducing noise and can be reduced in size.

### Solution to Problem

A power conversion device according to one aspect of the present disclosure includes: a first switch provided on a first path connecting a first input/output terminal and a second input/output terminal; a second switch provided on the first path and connected in series with the first switch; a first inductor provided on a second path connecting a third input/output terminal and a connecting node located between the first switch and the second switch on the first path; a first current sensor circuit that detects an electric current flowing to the first inductor; and a first resonant period detection circuit that detects a resonant period of a first resonance phenomenon based on parasitic capacitance of the first switch and the second switch and inductance of the first inductor, the first resonance phenomenon occurring by switching operations of the first switch and the second switch. Energy accumulates in the first inductor in a first energy application period in which the second switch is OFF and the first switch is ON. The first resonance phenomenon occurs due to the energy that has accumulated in the first inductor in the first energy application period. The first resonant period detection circuit detects the resonant period of the first resonance phenomenon based on a result of comparison between a reference voltage and a voltage generated from a resonance current flowing to the first inductor due to the first resonance phenomenon and detected by the first current sensor circuit.

### Advantageous Effects of Invention

The power conversion device according to one aspect of the present disclosure is capable of reducing noise and can be reduced in size.

### BRIEF DESCRIPTION OF DRAWINGS

FIG. 1 is a configuration diagram illustrating one example of a power conversion device according to Embodiment 1.

FIG. 2 is a diagram for describing zero voltage switching.

FIG. 3 is a diagram illustrating one example of a resonant period detected for zero voltage switching.

FIG. 4 is a diagram illustrating another example of a resonant period detected for zero voltage switching.

FIG. 5 is a diagram illustrating one example of the timing of correcting a set value for zero voltage switching.

FIG. 6 is a diagram illustrating another example of the timing of correcting a set value for zero voltage switching.

FIG. 7 is a configuration diagram illustrating one example of a power conversion device according to Embodiment 2.

FIG. 8 is a diagram for describing zero voltage switching when two inductors are coupled together.

FIG. 9 is a diagram illustrating one example of a first resonant period detection period.

FIG. 10 is a diagram illustrating another example of a first resonant period detection period.

FIG. 11 is a diagram illustrating one example of a first energy application period.

FIG. 12 is a diagram illustrating another example of a first energy application period.

FIG. 13 is a configuration diagram illustrating one example of a power conversion device according to Embodiment 3.

FIG. 14 is a diagram illustrating one example of a second resonant period detection period.

FIG. 15 is a diagram illustrating another example of a second resonant period detection period.

FIG. 16 is a diagram illustrating one example of a second energy application period.

FIG. 17 is a diagram illustrating another example of a second energy application period.

### DESCRIPTION OF EMBODIMENTS

Hereinafter, embodiments will be specifically described with reference to the drawings.

Note that each of the embodiments described below shows a general or specific example. The numerical values, shapes, materials, structural elements, the arrangement and connection of the structural elements, etc., shown in the following embodiments are mere examples, and are not intended to limit the scope of the present disclosure.

### Embodiment 1

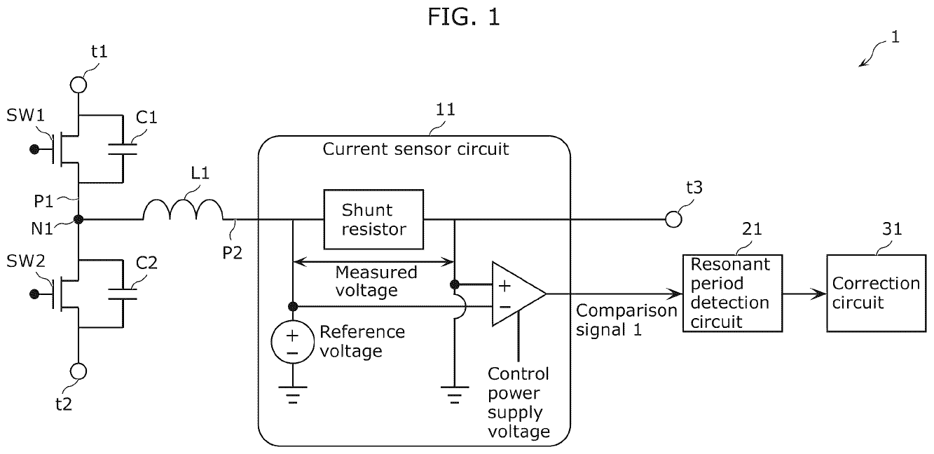

Power conversion device 1 according to Embodiment 1 will be described with reference to FIG. 1 to FIG. 6.

FIG. 1 is a configuration diagram illustrating one example of power conversion device 1 according to Embodiment 1.

Power conversion device 1 is a device that steps up or down an input voltage to a predetermined voltage and outputs the predetermined voltage; in the following description, a step-down converter is given as an example of power conversion device 1. Power conversion device 1 steps down an input voltage applied between input/output terminal t1 and input/output terminal t2, and outputs the stepped-down voltage from input/output terminal t3. Input/output terminal t1 is one example of the first input/output terminal, input/output terminal t2 is one example of the second input/output terminal, and input/output terminal t3 is one example of the third input/output terminal. Note that power conversion device 1 may be a step-up converter.

Power conversion device 1 includes switches SW1, SW2, inductor L1, current sensor circuit 11, resonant period detection circuit 21, and correction circuit 31. Switch SW1 is one example of the first switch, switch SW2 is one example of the second switch, inductor L1 is one example of the first inductor, current sensor circuit 11 is one example of the first current sensor circuit, resonant period detection circuit 21 is one example of the first resonant period detection circuit, and correction circuit 31 is one example of the first correction circuit.

Switch SW1 is provided on path P1 connecting input/output terminal t1 and input/output terminal t2. Path P1 is one example of the first path. Switch SW1 is an N-channel metal oxide semiconductor field effect transistor (MOSFET), for example. In FIG. 1, the parasitic capacitance of switch SW1 is shown as capacitor C1, and capacitor C1 is connected in parallel with switch SW1 on an equivalent circuit.

Switch SW2, which is provided on path P1, is connected in series with switch SW1. Switch SW2 is an N-channel MOSFET, for example. In FIG. 1, the parasitic capacitance of switch SW2 is shown as capacitor C2, and capacitor C2 is connected in parallel with switch SW2 on an equivalent circuit.

Power conversion device 1 may include the function of controlling ON and OFF of each of switches SW1, SW2. Alternatively, a device different from power conversion device 1 may control ON and OFF of each of switches SW1, SW2.

Inductor L1 is provided on path P2 connecting input/output terminal t3 and connecting node N1 located between switch SW1 and switch SW2 on path P1. Path P2 is one example of the second path.

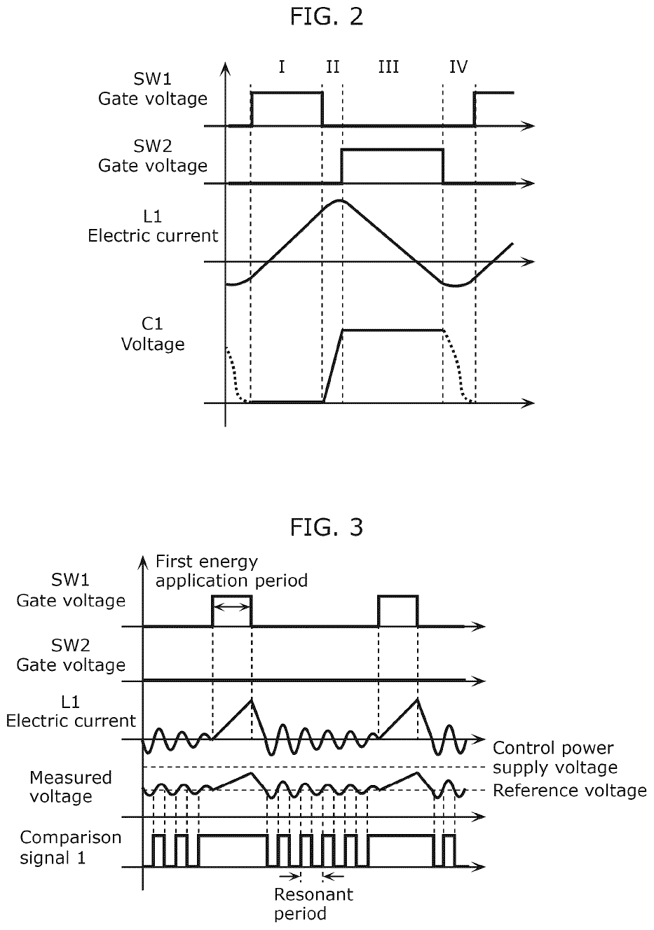

There has been an increased need for a reduction in the size of power conversion devices such as on-board chargers and alternating-current (AC) adapters; particularly, there has been an increased need for a reduction in the size of passive components such as inductors and capacitors that make up a significant part of the power conversion device in terms of size. If a drive frequency applied to a passive component that has not yet been reduced in size is applied to the passive component reduced in size, ripple current increases and therefore, the power conversion device needs to be driven at a high frequency. However, if the power conversion device is driven at a high frequency, a switching loss occurs at every switching and therefore, it is necessary to perform soft switching. As soft switching, zero voltage switching will be described next with reference to FIG. 2.

FIG. 2 is a diagram for describing zero voltage switching.

In period I, switch SW1 is turned ON and switch SW2 is turned OFF and thus, a forward current flows to inductor L1, meaning that electric power is transferred to input/output terminal t3 while energy accumulates in inductor L1.

In period II, switch SW1 is turned OFF and the voltage of capacitor C1 increases to the input voltage applied between input/output terminal t1 and input/output terminal t2 due to resonance, and then switch SW2 is turned ON.

In period III, a forward current flows to inductor L1, the energy that has accumulated in inductor L1 is released, electric power is transferred to input/output terminal t3, and when the energy stored in inductor L1 is completely released and switch SW2 is ON, a reverse current flows to inductor L1.

In period IV, switch SW2 is turned OFF, the voltage of capacitor C1 drops to 0 V due to resonance, and then switch SW1 is turned ON.

Period IV in which switches SW1, SW2 are OFF before switch SW1 is turned ON is referred to as deadtime of switches SW1, SW2. In the operation in the current critical mode (CRM), switch SW1 needs to be turned ON while the voltage of capacitor C1 is 0 V during this deadtime. This is because if the deadtime is short and switch SW1 is turned ON before the voltage of capacitor C1 drops to 0 V, turn-on losses increase. Conversely, if the deadtime is long and switch SW1 is turned ON after the lapse of a predetermined period after the drop of the voltage of capacitor C1 to 0 V, conduction losses increase because the diode mode is excessive. Therefore, in order to realize efficient and stable operation of power conversion device 1, it is necessary to properly adjust the deadtime. The period to the drop of the voltage of capacitor C1 to 0 V is derived from the resonant period of a resonance phenomenon (also referred to a first resonance phenomenon) based on the capacitance of capacitors C1, C2 (in other words, the parasitic capacitance of switches SW1, SW2) and the inductance of inductor L1, the deadtime is adjusted according to said resonant period, and thus zero voltage switching can be performed.

In order to detect the resonant period of the first resonance phenomenon and adjust the deadtime of switches SW1, SW2 according to said resonant period, power conversion device 1 includes current sensor circuit 11, resonant period detection circuit 21, and correction circuit 31.

Current sensor circuit 11 senses an electric current flowing to inductor L1. For example, current sensor circuit 11 includes a shunt resistor, a reference power supply, and a comparator. The shunt resistor, which is provided on path P2, is connected in series with inductor L1. Specifically, the shunt resistor is provided between inductor L1 and input/output terminal t3 on path P2. One end of the shunt resistor, inductor L1, the reference power supply, and the negative input terminal of the comparator are connected, and the other end of the shunt resistor, input/output terminal t3, the ground, and the positive input terminal of the comparator are connected. For example, the ground for switches SW1, SW2 and the ground in current sensor circuit 11 are separate. Comparison signal 1 is output from the output terminal of the comparator. Note that by using a magnetic core, a Hall element, or the like, current sensor circuit 11 may contactlessly sense the electric current flowing to inductor L1.

Current sensor circuit 11 is configured so that at the timing of switching between the positive and negative values of a resonance current flowing to inductor L1 due to the first resonance phenomenon, the magnitude relation of a voltage generated from the resonance current with respect to a reference voltage is switched. The functions of current sensor circuit 11 will be described in greater detail below.

Resonant period detection circuit 21 detects the resonant period of the first resonance phenomenon based on the parasitic capacitance of switches SW1, SW2 and the inductance of inductor L1 that occurs by the switching operations of switches SW1, SW2. Resonant period detection circuit 21 detects the resonant period of the first resonance phenomenon in order to achieve zero voltage switching of switches SW1, SW2 as mentioned above. Next, the resonant period detected for zero voltage switching will be described with reference to FIG. 3.

FIG. 3 is a diagram illustrating one example of the resonant period detected for zero voltage switching.

As illustrated in FIG. 3, energy accumulates in inductor L1 in the first energy application period in which switch SW2 is OFF and switch SW1 is ON. The first resonance phenomenon occurs due to the energy that has accumulated in inductor L1 in the first energy application period. As illustrated in FIG. 3, when switch SW1 is turned OFF after energy accumulation in inductor L1, the first resonance phenomenon occurs, and a resonance current flows to inductor L1.

The reference voltage of the reference power supply included in current sensor circuit 11 is, for example, about one half of the control power supply voltage of the comparator included in current sensor circuit 11. An electric current flows to the shunt resistor in the same manner as the resonance current flowing to inductor L1, and a voltage is generated from the resonance current through the shunt resistor. This voltage is indicated as measured voltage in FIG. 1 and FIG. 3. When the resonance current flowing to inductor L1 switches between positive and negative values, the magnitude relation of a voltage applied to the positive input terminal of the comparator (that is, the measured voltage) with respect to a voltage applied to the negative input terminal of the comparator (that is, the reference voltage) is switched. FIG. 3 also shows that at the timing of switching between the positive and negative values of the resonance current flowing to inductor L1, the magnitude relation of the voltage generated from said resonance current with respect to the reference voltage is switched. Thus, the comparator outputs comparison signal 1 corresponding to the switched magnitude relation of the voltage generated from the resonance current with respect to the reference voltage.

Resonant period detection circuit 21 detects the resonant period of the first resonance phenomenon on the basis of the result of comparison between the reference voltage and the voltage generated from the resonance current flowing to inductor L1 due to the first resonance phenomenon that is the electric current sensed by current sensor circuit 11 (specifically, comparison signal 1). The resonant period of the first resonance phenomenon is the period from the rising edge, then the falling edge, and to the next rising edge of comparison signal 1 as illustrated in FIG. 3; by measuring this period, resonant period detection circuit 21 can detect the resonant period of the first resonance phenomenon. In this manner, only by detecting the timing of switching of the magnitude relation of the voltage generated from the resonance current with respect to the reference voltage, it is possible to easily detect the resonant period required for zero voltage switching of switches SW1, SW2.

Note that resonant period detection circuit 21 may detect the resonant period of the first resonance phenomenon by using the amount of time from the first switching to the next switching between the positive and negative values of the resonance current flowing to inductor L1 due to the first resonance phenomenon. This will be described with reference to FIG. 4.

FIG. 4 is a diagram illustrating another example of the resonant period detected for zero voltage switching.

As illustrated in FIG. 4, the first resonance phenomenon is gradually attenuated and therefore, there is a risk that when the resonant period of the first resonance phenomenon is detected after the lapse of a certain amount of time after the occurrence of the first resonance phenomenon, the accuracy of the detection may be low. In contrast, when the resonant period of the first resonance phenomenon is detected using the amount of time from the first switching to the next switching between the positive and negative values of the resonance current flowing to inductor L1 (in other words, a half period), the resonant period can be detected while the first resonance phenomenon is barely attenuated. Therefore, it is possible to accurately detect the resonant period required for zero voltage switching of switches SW1, SW2.

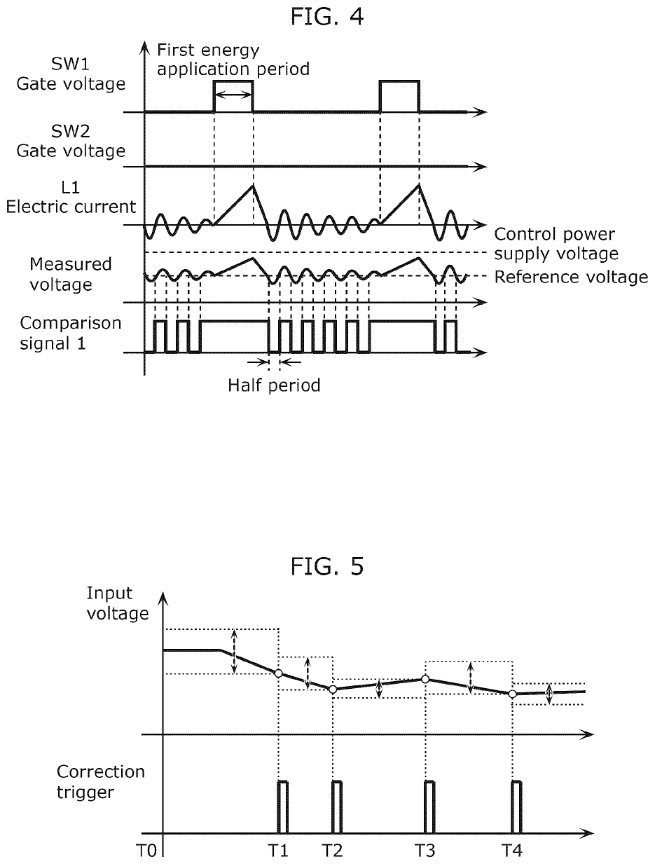

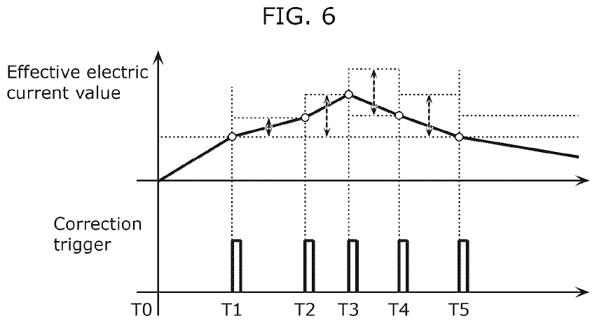

Using the resonant period of the first resonance phenomenon detected by resonant period detection circuit 21, correction circuit 31 performs a first correction of a set value for zero voltage switching of switches SW1, SW2. This set value is a value for adjusting the deadtime of switches SW1, SW2. For example, this set value can be determined from the nominal values of the inductance of inductor L1 and the parasitic capacitance of switches SW1, SW2; however, the inductance of inductor L1 may deviate from the nominal value thereof depending on circumstances, and the deadtime may become too long or too short accordingly, which is inappropriate. Therefore, correction circuit 31 performs the first correction when the inductance of inductor L1 has changed to some degree. Next, the timing of correcting the set value will be described with reference to FIG. 5 and FIG. 6.

FIG. 5 is a diagram illustrating one example of the timing of correcting the set value for zero voltage switching.

Since the capacitance of capacitors C1, C2 changes according to the input voltage, correction circuit 31 performs the first correction again, for example, when the voltage between input/output terminal t1 and input/output terminal t2 (the input voltage) has changed from the input voltage obtained the last time the first correction was performed, by at least a predetermined percentage of said input voltage.

As illustrated in FIG. 5, the upper and lower dashed lines drawn for the input voltage at time TO indicate voltages at a predetermined percentage (for example, plus and minus 10%) of said input voltage and when the current input voltage exceeds these voltages, the first correction is performed. At time T1, the current input voltage is lower than the input voltage at time TO by the predetermined percentage, and thus the first correction is performed. Next, at time T2, the current input voltage is lower than the input voltage obtained at time T1, at which the last first correction was performed, by the predetermined percentage, and thus the first correction is performed. Next, at time T3, the current input voltage is higher than the input voltage obtained at time T2, at which the last first correction was performed, by the predetermined percentage, and thus the first correction is performed. Next, at time T4, the current input voltage is lower than the input voltage obtained at time T3, at which the last first correction was performed, by the predetermined percentage, and thus the first correction is performed.

In this manner, the capacitance of capacitors C1, C2 changes according to the input voltage and therefore, when the first correction is performed every time the input voltage has changed to some degree, the deadtime of switches SW1, SW2 can be maintained at an optimum level.

FIG. 6 is a diagram illustrating another example of the timing of correcting the set value for zero voltage switching.

When the effective value of the electric current flowing to inductor L1 is greater than or equal to a predetermined threshold value, the inductance of inductor L1 changes according to said effective value and therefore, for example, when the effective value of the electric current flowing to inductor L1 has changed from the effective value of the electric current flowing to inductor L1 the last time the first correction was performed, by at least a predetermined percentage of said effective value, correction circuit 31 performs the first correction again.

As illustrated in FIG. 6, the first correction is performed at time T1 at which the effective value of the electric current flowing to inductor L1 exceeds a predetermined threshold value. At time T2, the current effective value is larger than the effective value at time T1 by a predetermined percentage (for example, 10%) and therefore, the first correction is performed again. Next, at time T3, the current effective value is larger than the effective value at time T2 by the predetermined percentage and therefore, the first correction is performed again. Next, at time T4, the current effective value is smaller than the effective value at time T3 by the predetermined percentage and therefore, the first correction is performed again. Next, at time T5, the current effective value is smaller than the effective value at time T4 by the predetermined percentage and therefore, the first correction is performed again.

In this manner, the inductance of inductor L1 changes according to the effective value of the electric current flowing to inductor L1 and therefore, when the first correction is performed every time said effective value has changed to some degree, the deadtime of switches SW1, SW2 can be maintained at an optimum level.

As described above, the resonant period required for zero voltage switching of switches SW1, SW2 is detected on the basis of the resonance current flowing to inductor L1 instead of the voltage at each end of inductor L1. Specifically, by detecting the direction of the resonance current flowing to inductor L1, it is possible to detect the resonant period, meaning that single current sensor circuit 11 will suffice and the circuit size can be reduced. Furthermore, there are cases where current sensor circuit 11 has already been provided for the operation in the CRM and in such cases, the resonant period can be detected using current sensor circuit 11 that has already been provided and therefore, the increase in circuit size can be minimized. Moreover, since a resonance current which varies more gradually than a resonance voltage is used in the detection of the resonant period, noise is less likely to be superimposed during the detection of the resonant period. Thus, power conversion device 1 according to the present disclosure is capable of reducing noise and can be reduced in size.

### Embodiment 2

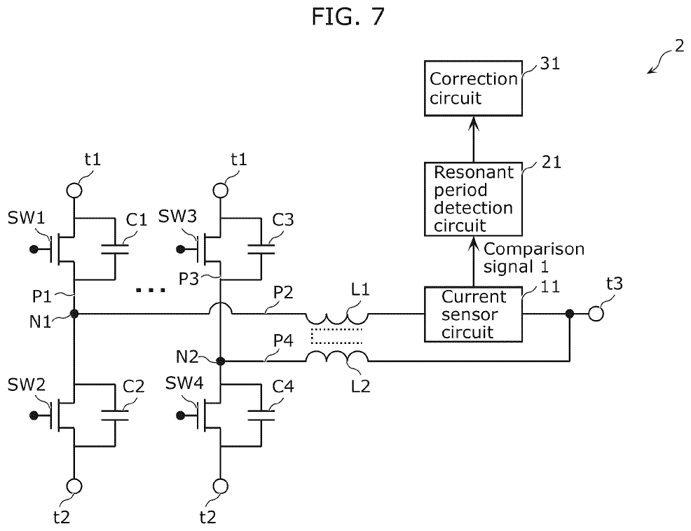

Power conversion device 2 according to Embodiment 2 will be described with reference to FIG. 7 to FIG. 12.

FIG. 7 is a configuration diagram illustrating one example of power conversion device 2 according to Embodiment 2.

Power conversion device 2 is different from power conversion device 1 according to Embodiment 1 in that power conversion device 2 further includes switches SW3, SW4 and inductor L2, in other words, power conversion device 2 is a two-phase converter. The other features are basically the same as those in Embodiment 1; therefore, the following description will focus on differences.

Switch SW3 is one example of the third switch, switch SW4 is one example of the fourth switch, and inductor L2 is one example of the second inductor.

Switch SW3 is provided on path P3, which is different from path P1, connecting input/output terminal t1 and input/output terminal t2. Path P3 is one example of the third path. Switch SW3 is an N-channel MOSFET, for example. In FIG. 7, the parasitic capacitance of switch SW3 is shown as capacitor C3, and capacitor C3 is connected in parallel with switch SW3 on an equivalent circuit.

Switch SW4, which is provided on path P2, is connected in series with switch SW3. Switch SW4 is an N-channel MOSFET, for example. In FIG. 7, the parasitic capacitance of switch SW4 is shown as capacitor C4, and capacitor C4 is connected in parallel with switch SW4 on an equivalent circuit. A series circuit of switches SW1, SW2 and a series circuit of switches SW3, SW4 are connected in parallel between input/output terminal t1 and input/output terminal t2.

Power conversion device 2 may include the function of controlling ON and OFF of each of switches SW3, SW4. Alternatively, a device different from power conversion device 2 may control ON and OFF of each of switches SW3, SW4.

Inductor L2 is provided on path P4 connecting input/output terminal t3 and connecting node N2 located between switch SW3 and switch SW4 on path P3. Path P4 is one example of the fourth path.

Inductor L1 and inductor L2 are magnetically coupled together. When inductor L1 and inductor L2 are magnetically coupled together, the effective inductance of inductors L1, L2 changes due to the impact of an electric current flowing to inductors L1, L2, in other words, by the switching operations of switches SW1 to SW4 which control the electric current flowing to inductors L1, L2. Specifically, the effective inductance of inductors L1, L2 changes according to the relationship of voltages at both ends of inductors L1, L2 determined by the switching operations of switches SW1 to SW4.

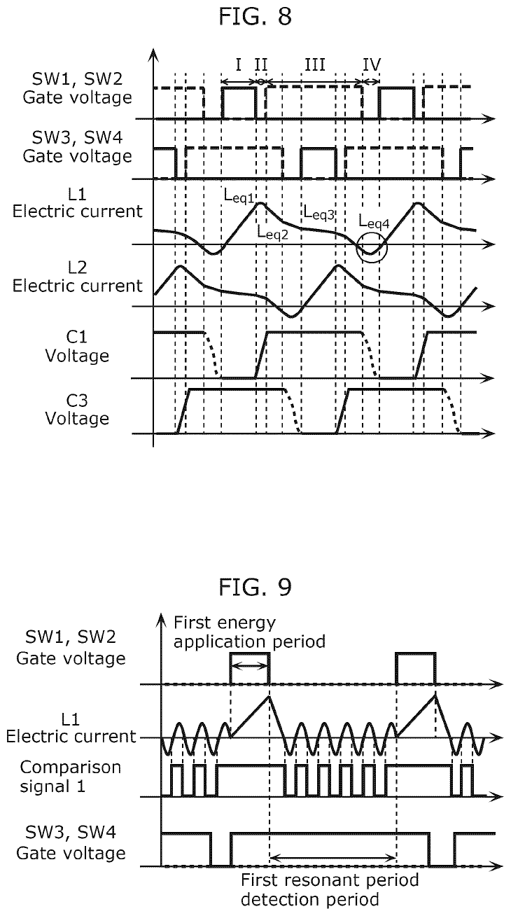

In Embodiment 2, the first resonance phenomenon is a resonance phenomenon that occurs by the switching operations of switches SW1 to SW4 and is based on the parasitic capacitance of switches SW1, SW2 and the effective inductance (the self-inductance and the mutual inductance) of inductor L1 coupled to inductor L2. Next, the zero voltage switching to be performed when inductor L1 and inductor L2 are coupled together will be described with reference to FIG. 8.

FIG. 8 is a diagram for describing zero voltage switching when two inductors L1, L2 are coupled together. In the graph indicating ON and OFF (H and L of the gate voltage) of each of switches SW1, SW2, switch SW1 is indicated by the solid lines, and switch SW2 is indicated by the dashed lines. In the graph indicating ON and OFF (H and L of the gate voltage) of each of switches SW3, SW4, switch SW3 is indicated by the solid lines, and switch SW4 is indicated by the dashed lines. Note that the same applies to FIG. 9 to FIG. 12 and FIG. 14 to FIG. 17, which will be described below.

In period I, switch SW1 is turned ON and switch SW2 is turned OFF and thus, a forward current flows to inductor L1, meaning that electric power is transferred to input/output terminal t3 while energy accumulates in inductor L1. At this time, switch SW3 is OFF and switch SW4 is ON, and the effective inductance (L_{eq1}) of inductor L1 is represented by Equation 1 indicated below. Note that L is the self-inductance of each of inductors L1, L2, M is the mutual inductance of inductors L1, L2, d is a duty cycle, and d′ is 1-d.

### [Math. 1]

$${L}_{eq 1} = \frac{{L}^{2} - {M}^{2}}{L + M \frac{d}{d ′}} \qquad ( Equation 1 )$$

In period II, switch SW1 is turned OFF and the voltage of capacitor C1 increases to the input voltage applied between input/output terminal t1 and input/output terminal t2, and then switch SW2 is turned ON. At this time, switch SW3 is OFF and switch SW4 is ON, and the effective inductance (L_{eq2}) of inductor L1 is represented by Equation 2 indicated below.

$$\begin{matrix}[ Math . 2 ] & \\ {L}_{eq 2} = L + M & ( Equation 2 )\end{matrix}$$

In period III, a forward current flows to inductor L1, the energy that has accumulated in inductor L1 is released, electric power is transferred to input/output terminal t3, and then a reverse current flows to inductor L1. When switch SW3 is ON and switch SW4 is OFF, the effective inductance (L_{eq3}) of inductor L1 is represented by Equation 3 indicated below.

$$\begin{matrix}[ Math . 3 ] & \\ {L}_{eq 3} = \frac{{L}^{2} - {M}^{2}}{L + M \frac{d}{d ′}} & ( Equation 3 )\end{matrix}$$

In period IV, switch SW2 is turned OFF, the voltage of capacitor C1 drops to 0 V due to resonance, and then switch SW1 is turned ON. At this time, switch SW3 is OFF and switch SW4 is ON, and the effective inductance (L_{eq4}) of inductor L1 is represented by Equation 4 indicated below.

$$\begin{matrix}[ Math . 4 ] & \\ {L}_{eq 4} = L - \frac{{M}^{2}}{L} & ( Equation 4 )\end{matrix}$$

Period IV in which switches SW1, SW2 are OFF before switch SW1 is turned ON is the deadtime of switches SW1, SW2; in the operation in the CRM, switch SW1 needs to be turned ON while the voltage of capacitor C1 is 0 V during this deadtime. The period to the drop of the voltage of capacitor C1 to 0 V is derived from the resonant period of the first resonance phenomenon based on the parasitic capacitance of switches SW1, SW2 and the effective inductance of inductor L1, the deadtime is adjusted according to said resonant period, and thus zero voltage switching can be performed. Note that in Embodiment 2, since inductor L1 and inductor L2 are magnetically coupled together, the first resonance phenomenon is a resonance phenomenon based on the parasitic capacitance of switches SW1, SW2 and the self-inductance and the mutual inductance of inductor L1 coupled to inductor L2. Therefore, in Embodiment 2, the deadtime required for zero voltage switching of switches SW1, SW2 is adjusted according to the effective inductance (L_{eq4}) of inductor L1 in period IV that is determined by Equation 4 indicated above.

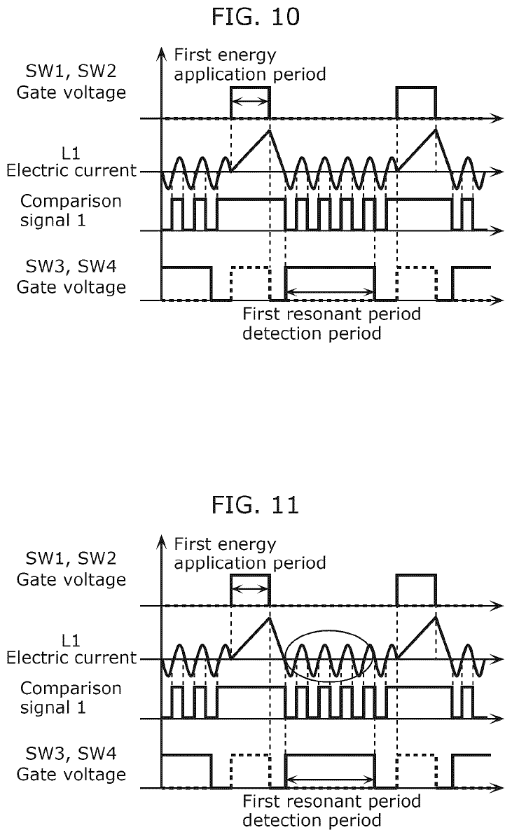

In order to adjust said deadtime, resonant period detection circuit 21 detects the resonant period of the first resonance phenomenon in the first resonant period detection period. Next, the first resonant period detection period will be described with reference to FIG. 9 and FIG. 10.

FIG. 9 is a diagram illustrating one example of the first resonant period detection period.

The resonant period of the first resonance phenomenon changes according to the effective inductance of inductor L1 coupled to inductor L2, and the effective inductance of inductor L1 changes according to the ON/OFF state of switches SW1 to SW4. Since the resonant period of the first resonance phenomenon is detected in order to adjust the deadtime of switches SW1, SW2, it is necessary to detect the resonant period of the first resonance phenomenon while the ON/OFF state of switches SW1 to SW4 is the same as the ON/OFF state of the switches during the deadtime of switches SW1, SW2. The ON/OFF state of the switches during the deadtime of switches SW1, SW2 is a state where switches SW1, SW2 are OFF, one of switches SW3, SW4 is ON, and the other of switches SW3, SW4 is OFF. In this state, the effective inductance of inductor L1 is L_{eq4}. In other words, the condition under which the effective inductance of inductor L1 is to be L_{eq4} is that switches SW1, SW2 are OFF, one of switches SW3, SW4 is ON, and the other of switches SW3, SW4 is OFF. Therefore, in the first resonant period detection period, switches SW1, SW2 need to be OFF, one of switches SW3, SW4 needs to be ON, and the other of switches SW3, SW4 needs to be OFF.

For example, a period in which switches SW1, SW2 are OFF, switch SW3 is ON, and switch SW4 is OFF is the first resonant period detection period, as illustrated in FIG. 9. Note that a period in which switches SW1, SW2 are OFF, switch SW3 is OFF, and switch SW4 is ON may be the first resonant period detection period.

FIG. 10 is a diagram illustrating another example of the first resonant period detection period.

Since power conversion device 2 is a two-phase converter as illustrated in FIG. 7, it is possible to transfer electric power to input/output terminal t3 by using switches SW3, SW4 and inductor L2 in order to detect the resonant period of the first resonance phenomenon even while no electric power is transferred to input/output terminal t3 by using switches SW1, SW2 and inductor L1. When electric power is transferred to input/output terminal t3 by using switches SW3, SW4 and inductor L2, switches SW3, SW4 are repeatedly turned ON and OFF at an arbitrary duty cycle, and there is a situation where one of switches SW3, SW4 is ON while the other of switches SW3, SW4 is OFF, as illustrated in FIG. 10.

Accordingly, the first resonant period detection period may be the ON time of one of switches SW3, SW4 that is ON for a greater amount of time when electric power is transferred to input/output terminal t3 by using switches SW3, SW4 and inductor L2. For example, when the ON time of switch SW3 is longer than the ON time of switch SW4, the first resonant period detection period may be the ON time of switch SW3 when electric power is transferred, as illustrated in FIG. 10.

When the first resonant period detection period is set to the ON time of one of switches SW3, SW4 that is ON for a greater amount of time, the period for detecting the resonant period of the first resonance phenomenon can be increased and therefore, the resonant period required for zero voltage switching of switches SW1, SW2 can be detected accurately.

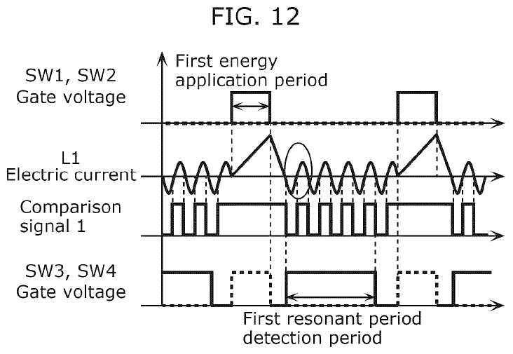

Next, the first energy application period will be described with reference to FIG. 11 and FIG. 12.

FIG. 11 is a diagram illustrating one example of the first energy application period.

If there is a long interval between the first energy application period and the first resonant period detection period, the resonance current in at least one period is not included in the first resonant period detection period, meaning that the resonant period of the first resonance phenomenon cannot be detected in the first resonant period detection period. Therefore, the first energy application period is set so that the resonance current flowing to inductor L1, in at least one period, due to the first resonance phenomenon is included in the first resonant period detection period. FIG. 11 illustrates an example where the first energy application period is set so that the resonance current in at least one period is included in the first resonant period detection period; the circled area in FIG. 11 shows that the resonance current in four periods is included in the first resonant period detection period.

By setting the first energy application period so that the resonance current in at least one period is included in the first resonant period detection period, it is possible to detect the resonant period required for zero voltage switching of switches SW1, SW2 in the first resonant period detection period.

FIG. 12 is a diagram illustrating another example of the first energy application period.

For example, the first energy application period may be set so that the resonance current flowing to inductor L1, in the initial one period, due to the first resonance phenomenon is included in the first resonant period detection period. FIG. 12 illustrates an example where the first energy application period is set so that the resonance current in the initial one period is included in the first resonant period detection period; the circled area in FIG. 12 shows that the resonance current in the initial one period is included in the first resonant period detection period.

Since the resonance current in the initial one period is barely attenuated, by setting the first energy application period so that the resonance current in the initial one period is included in the first resonant period detection period, it is possible to accurately detect the resonant period required for zero voltage switching of switches SW1, SW2 in the first resonant period detection period.

The operations of current sensor circuit 11, resonant period detection circuit 21, and correction circuit 31 are basically the same as those in Embodiment 1. Resonant period detection circuit 21 detects the resonant period of the first resonance phenomenon using comparison signal 1 output from current sensor circuit 11 in the first resonant period detection period. Correction circuit 31 performs the first correction at the correction timing described in Embodiment 1. Specifically, when switch SW1 is ON and switch SW2 is OFF, energy is applied to inductor L1 and switch SW1 is turned OFF, the resonant period of the first resonance phenomenon is detected while one of switches SW3, SW4 is ON and the other of switches SW3, SW4 is OFF, and correction circuit 31 performs the first correction by correcting the set value for zero voltage switching of switches SW1, SW2 by using said resonant period.

As described above, in Embodiment 2, power conversion device 2 is a two-phase converter in which inductor L1 and inductor L2 are magnetically coupled together, allowing for a quicker response to load variations (specifically, variations in the electric current flowing to a load). Furthermore, when inductor L1 and inductor L2 are magnetically coupled together, some parts of inductor L1 and inductor L2 can be shared, meaning that the overall size of inductors L1, L2 can be reduced.

Furthermore, by detecting the resonant period of the first resonance phenomenon when switches SW1, SW2 are OFF, one of switches SW3, SW4 is ON, and the other of switches SW3, SW4 is OFF, it is possible to accurately detect the resonant period required for zero voltage switching of switches SW1, SW2 even when inductor L1 and inductor L2 are coupled together.

### Embodiment 3

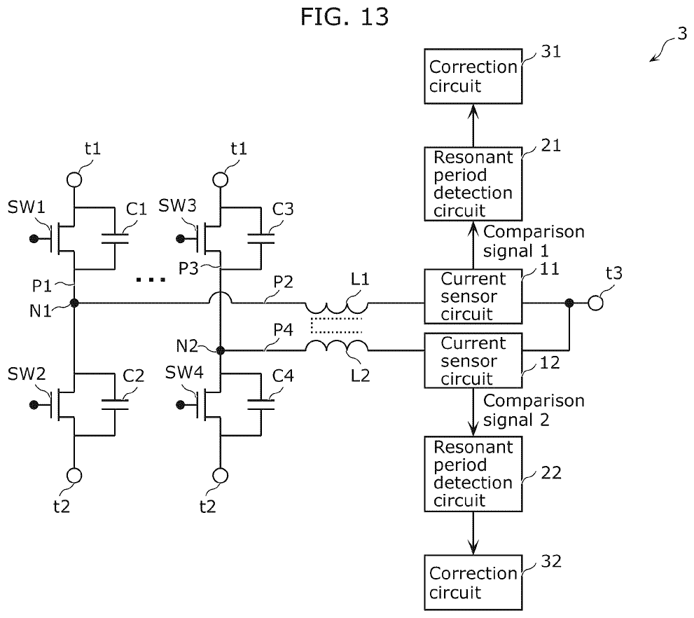

Power conversion device 3 according to Embodiment 3 will be described with reference to FIG. 13 to FIG. 17.

FIG. 13 is a configuration diagram illustrating one example of power conversion device 3 according to Embodiment 3.

Power conversion device 3 is different from power conversion device 2 according to Embodiment 2 in that power conversion device 3 further includes current sensor circuit 12, resonant period detection circuit 22, and correction circuit 32 and is capable of adjusting not only the deadtime of switches SW1, SW2, but also the deadtime of switches SW3, SW4. The other features are basically the same as those in Embodiment 2; therefore, the following description will focus on differences.

Current sensor circuit 12 is one example of the second current sensor circuit, resonant period detection circuit 22 is one example of the second resonant period detection circuit, and correction circuit 32 is one example of the second correction circuit. Current sensor circuit 12, resonant period detection circuit 22, and correction circuit 32 will be described in greater detail below.

The zero voltage switching is also applied to switches SW3, SW4. The period in which switches SW3, SW4 are OFF before switch SW3 is turned ON is the deadtime of switches SW3, SW4. In the operation in the CRM, switch SW3 needs to be turned ON while the voltage of capacitor C3 is 0 V during this deadtime. This is because if the deadtime is short and switch SW3 is turned ON before the voltage of capacitor C3 drops to 0 V, turn-on losses increase. Conversely, if the deadtime is long and switch SW3 is turned ON after the lapse of a predetermined period after the drop of the voltage of capacitor C3 to 0 V, conduction losses increase because the diode mode is excessive. Therefore, in order to realize efficient and stable operation of power conversion device 3, it is necessary to properly adjust the deadtime. The period to the drop of the voltage of capacitor C3 to 0 V is derived from the resonant period of a resonance phenomenon (also referred to a second resonance phenomenon) based on the parasitic capacitance of switches SW3, SW4 and the effective inductance of inductor L2, the deadtime is adjusted according to said resonant period, and thus zero voltage switching can be performed.

In order to detect the resonant period of the second resonance phenomenon and adjust the deadtime of switches SW3, SW4 according to said resonant period, power conversion device 3 includes current sensor circuit 12, resonant period detection circuit 22, and correction circuit 32.

Current sensor circuit 12 senses an electric current flowing to inductor L2. For example, current sensor circuit 12, which has substantially the same circuit configuration as current sensor circuit 11 illustrated in FIG. 1, outputs comparison signal 2. Note that by using a magnetic core, a Hall element, or the like, current sensor circuit 12 may contactlessly sense the electric current flowing to inductor L1.

Current sensor circuit 12 is configured so that at the timing of switching between the positive and negative values of a resonance current flowing to inductor L2 due to the second resonance phenomenon, the magnitude relation of a voltage generated from the resonance current with respect to a reference voltage is switched. The functions of current sensor circuit 12 will be described in greater detail below.

Resonant period detection circuit 22 detects the resonant period of the second resonance phenomenon based on the parasitic capacitance of switches SW3, SW4 and the inductance of inductor L2 that occurs by the switching operations of switches SW3, SW4. Resonant period detection circuit 22 detects the resonant period of the second resonance phenomenon in order to achieve zero voltage switching of switches SW3, SW4 as mentioned above.

Energy accumulates in inductor L2 in the second energy application period in which switch SW4 is OFF and switch SW3 is ON. The second resonance phenomenon occurs due to the energy that has accumulated in inductor L2 in the second energy application period.

The reference voltage of the reference power supply included in current sensor circuit 12 is, for example, about one half of the control power supply voltage of the comparator included in current sensor circuit 12. An electric current flows to the shunt resistor in the same manner as the resonance current flowing to inductor L2, and a voltage is generated from the resonance current through the shunt resistor. When the resonance current flowing to inductor L2 switches between positive and negative values, the magnitude relation of a voltage applied to the positive input terminal of the comparator (that is, the measured voltage) with respect to a voltage applied to the negative input terminal of the comparator (that is, the reference voltage) is switched. Thus, the comparator outputs comparison signal 2 corresponding to switching of the magnitude relation of the voltage generated from the resonance current with respect to the reference voltage.

Resonant period detection circuit 22 detects the resonant period of the second resonance phenomenon on the basis of the result of comparison between the reference voltage and the voltage generated from the resonance current flowing to inductor L2 due to the second resonance phenomenon that is the electric current sensed by current sensor circuit 12 (specifically, comparison signal 2). The resonant period of the second resonance phenomenon is the period from the rising edge, then the falling edge, and to the next rising edge of comparison signal 2; by measuring this period, resonant period detection circuit 22 can detect the resonant period of the second resonance phenomenon. In this manner, only by detecting the timing of switching of the magnitude relation of the voltage generated from the resonance current with respect to the reference voltage, it is possible to easily detect the resonant period required for zero voltage switching of switches SW3, SW4.

Note that resonant period detection circuit 22 may detect the resonant period of the second resonance phenomenon by using the amount of time from the first switching to the next switching between the positive and negative values of the resonance current flowing to inductor L2 due to the second resonance phenomenon.

The second resonance phenomenon is gradually attenuated and therefore, there is a risk that when the resonant period of the second resonance phenomenon is detected after the lapse of a certain amount of time after the occurrence of the second resonance phenomenon, the accuracy of the detection may be low. In contrast, when the resonant period of the second resonance phenomenon is detected using the amount of time from the first switching to the next switching between the positive and negative values of the resonance current flowing to inductor L2 (in other words, a half period), the resonant period can be detected while the second resonance phenomenon is barely attenuated. Therefore, it is possible to accurately detect the resonant period required for zero voltage switching of switches SW3, SW4.

Using the resonant period of the second resonance phenomenon detected by resonant period detection circuit 22, correction circuit 32 performs a second correction of a set value for zero voltage switching of switches SW3, SW4. This set value is a value for adjusting the deadtime of switches SW3, SW4. For example, this set value can be determined from the nominal values of the inductance of inductor L2 and the parasitic capacitance of switches SW3, SW4; however, the inductance of inductor L2 may deviate from the nominal value thereof depending on circumstances, and the deadtime may become inappropriate accordingly. Therefore, correction circuit 32 performs the second correction when the inductance of inductor L2 has changed to some degree.

Since the capacitance of capacitors C3, C4 changes according the input voltage, correction circuit 32 performs the second correction again, for example, when the voltage between input/output terminal t1 and input/output terminal t2 (the input voltage) has changed from the input voltage obtained the last time the second correction was performed, by at least a predetermined percentage of said input voltage.

In this manner, the capacitance of capacitors C3, C4 changes according to the input voltage and therefore, when the second correction is performed every time the input voltage has changed to some degree, the deadtime of switches SW3, SW4 can be maintained at an optimum level.

When the effective value of the electric current flowing to inductor L2 is greater than or equal to a predetermined threshold value, the inductance of inductor L2 changes according to said effective value and therefore, for example, when the effective value of the electric current flowing to inductor L2 has changed from the effective value of the electric current flowing to inductor L2 the last time the second correction was performed, by at least a predetermined percentage of said effective value, correction circuit 32 performs the second correction again.

In this manner, the inductance of inductor L2 changes according to the effective value of the electric current flowing to inductor L2 and therefore, when the second correction is performed every time said effective value has changed to some degree, the deadtime of switches SW3, SW4 can be maintained at an optimum level.

In Embodiment 3, the second resonance phenomenon is a resonance phenomenon that occurs by the switching operations of switches SW1 to SW4 and is based on the parasitic capacitance of switches SW3, SW4 and the effective inductance (the self-inductance and the mutual inductance) of inductor L2 coupled to inductor L1.

Regarding zero voltage switching applied when inductor L1 and inductor L2 are coupled together, the effective inductance of inductor L2 changes in the same manner as the effective inductance of inductor L1 described in Embodiment 2. Specifically, the effective inductance of inductor L2 changes to L_{eq1}, L_{eq2}, L_{eq3}, and L_{eq4} as described above. In the deadtime of switches SW3, SW4, the effective inductance of inductor L2 is L_{eq4} as in the deadtime of switches SW1, SW2.

In Embodiment 3, since inductor L1 and inductor L2 are magnetically coupled together, the second resonance phenomenon is a resonance phenomenon based on the parasitic capacitance of switches SW3, SW4 and the self-inductance and the mutual inductance of inductor L2 coupled to inductor L1. Therefore, in Embodiment 3, the deadtime required for zero voltage switching of switches SW3, SW4 is adjusted according to the resonant period of the second resonance phenomenon in which the effective inductance of inductor L2 is L_{eq4} in Equation 4 indicated above.

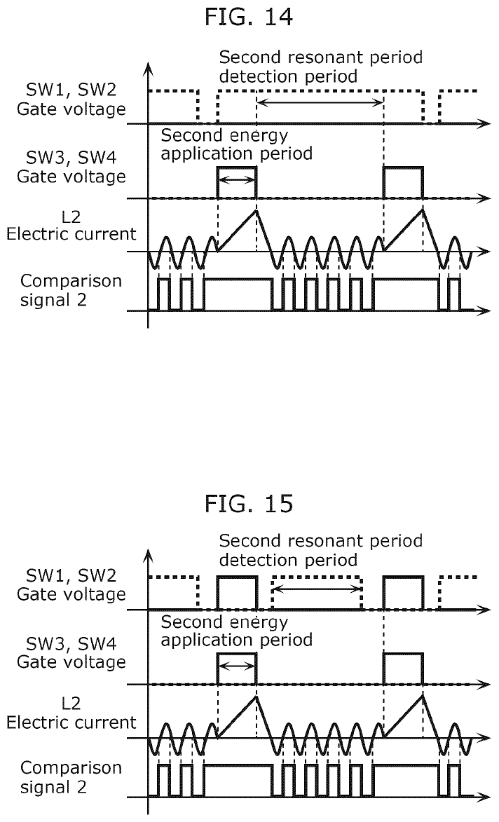

In order to adjust said deadtime, resonant period detection circuit 22 detects the resonant period of the second resonance phenomenon in the second resonant period detection period. Next, the second resonant period detection period will be described with reference to FIG. 14 and FIG. 15.

FIG. 14 is a diagram illustrating one example of the second resonant period detection period.

The resonant period of the second resonance phenomenon changes according to the effective inductance of inductor L2 coupled to inductor L1, and the effective inductance of inductor L2 changes according to the ON/OFF state of switches SW1 to SW4. Since the resonant period of the second resonance phenomenon is detected in order to adjust the deadtime of switches SW3, SW4, it is necessary to detect the resonant period of the second resonance phenomenon while the ON/OFF state of switches SW1 to SW4 is the same as the ON/OFF state of the switches during the deadtime of switches SW3, SW4. The ON/OFF state of the switches during the deadtime of switches SW3, SW4 is a state where switches SW3, SW4 are OFF, one of switches SW1, SW2 is ON, and the other of switches SW1, SW2 is OFF. In this state, the effective inductance of inductor L2 is L_{eq4}. In other words, the condition under which the effective inductance of inductor L2 is to be L_{eq4} is that switches SW3, SW4 are OFF, one of switches SW1, SW2 is ON, and the other of switches SW1, SW2 is OFF. Therefore, in the second resonant period detection period, switches SW3, SW4 need to be OFF, one of switches SW1, SW2 needs to be ON, and the other of switches SW1, SW2 needs to be OFF.

For example, a period in which switches SW3, SW4 are OFF, switch SW1 is OFF, and switch SW2 is ON is the second resonant period detection period, as illustrated in FIG. 14. Note that a period in which switches SW3, SW4 are OFF, switch SW1 is ON, and switch SW2 is OFF may be the second resonant period detection period.

FIG. 15 is a diagram illustrating another example of the second resonant period detection period.

Since power conversion device 3 is a two-phase converter as illustrated in FIG. 13, it is possible to transfer electric power to input/output terminal t3 by using switches SW1, SW2 and inductor L1 in order to detect the resonant period of the second resonance phenomenon even while no electric power is transferred to input/output terminal t3 by using switches SW3, SW4 and inductor L2. When electric power is transferred to input/output terminal t3 by using switches SW1, SW2 and inductor L1, switches SW1, SW2 are repeatedly turned ON and OFF at an arbitrary duty cycle, and there is a situation where one of switches SW1, SW2 is ON while the other of switches SW1, SW2 is OFF, as illustrated in FIG. 15.

Accordingly, the second resonant period detection period may be the ON time of one of switches SW1, SW2 that is ON for a greater amount of time when electric power is transferred to input/output terminal t3 by using switches SW1, SW2 and inductor L1. For example, when the ON time of switch SW2 is longer than the ON time of switch SW1, the second resonant period detection period may be the ON time of switch SW2 when electric power is transferred, as illustrated in FIG. 15.

When the second resonant period detection period is set to the ON time of one of switches SW1, SW2 that is ON for a greater amount of time, the period for detecting the resonant period of the second resonance phenomenon can be increased and therefore, the resonant period required for zero voltage switching of switches SW3, SW4 can be detected accurately.

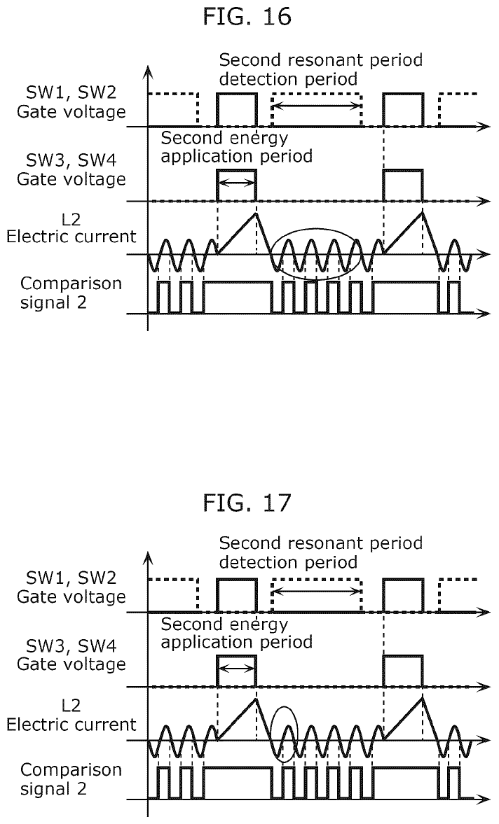

Next, the second energy application period will be described with reference to FIG. 16 and FIG. 17.

FIG. 16 is a diagram illustrating one example of the second energy application period.

If there is a long interval between the second energy application period and the second resonant period detection period, the resonance current in at least one period is not included in the second resonant period detection period, meaning that the resonant period of the second resonance phenomenon cannot be detected in the second resonant period detection period. Therefore, the second energy application period is set so that the resonance current flowing to inductor L2, in at least one period, due to the second resonance phenomenon is included in the second resonant period detection period. FIG. 16 illustrates an example where the second energy application period is set so that the resonance current in at least one period is included in the second resonant period detection period; the circled area in FIG. 16 shows that the resonance current in four periods is included in the second resonant period detection period.

By setting the second energy application period so that the resonance current in at least one period is included in the second resonant period detection period, it is possible to detect the resonant period required for zero voltage switching of switches SW3, SW4 in the second resonant period detection period.

FIG. 17 is a diagram illustrating another example of the second energy application period.

For example, the second energy application period may be set so that the resonance current flowing to inductor L2, in the initial one period, due to the second resonance phenomenon is included in the second resonant period detection period. FIG. 17 illustrates an example where the second energy application period is set so that the resonance current in the initial one period is included in the second resonant period detection period; the circled area in FIG. 17 shows that the resonance current in the initial one period is included in the second resonant period detection period.

Since the resonance current in the initial one period is barely attenuated, by setting the second energy application period so that the resonance current in the initial one period is included in the second resonant period detection period, it is possible to accurately detect the resonant period required for zero voltage switching of switches SW3, SW4 in the second resonant period detection period.

The operations of current sensor circuit 12, resonant period detection circuit 22, and correction circuit 32 are basically the same as those of current sensor circuit 11, resonant period detection circuit 21, and correction circuit 31. Resonant period detection circuit 22 detects the resonant period of the second resonance phenomenon using comparison signal 2 output from current sensor circuit 12 in the second resonant period detection period. Correction circuit 32 performs the second correction at the correction timing described above. Specifically, when switch SW3 is ON and switch SW4 is OFF, energy is applied to inductor L2 and switch SW3 is turned OFF, the resonant period of the second resonance phenomenon is detected while one of switches SW1, SW2 is ON and the other of switches SW1, SW2 is OFF, and correction circuit 32 performs the second correction by correcting the set value for zero voltage switching of switches SW3, SW4 by using said resonant period.

As described above, in Embodiment 3, the resonant period required for zero voltage switching of switches SW3, SW4 is also detected on the basis of the resonance current flowing to inductor L2. For example, the deadtime for zero voltage switching of switches SW3, SW4 can be adjusted while electric power is transferred to input/output terminal t3 by using switches SW1, SW2 and inductor L1, or the deadtime for zero voltage switching of switches SW1, SW2 can be adjusted while electric power is transferred to input/output terminal t3 by using switches SW3, SW4 and inductor L2.

Furthermore, by detecting the resonant period of the second resonance phenomenon when switches SW3, SW4 are OFF, one of switches SW1, SW2 is ON, and the other of switches SW1, SW2 is OFF, it is possible to accurately detect the resonant period required for zero voltage switching of switches SW3, SW4 even when inductor L1 and inductor L2 are coupled together.

### Other Embodiments

As described above, the embodiments are presented as exemplifications of the technique in the present disclosure. However, the technique according to the present disclosure is not limited to the foregoing embodiments, and can also be applied to embodiments to which a change, substitution, addition, or omission is executed as necessary. For example, the embodiments of the present disclosure include the following variations.

For example, in the above embodiments, the power conversion device is exemplified as including the correction circuit, but the power conversion device is not required to include the correction circuit.

For example, forms obtained by various modifications to the embodiments that can be conceived by those skilled in the art, and forms configured by arbitrarily combining structural elements and functions in the embodiments without departing from the teachings of the present disclosure are included in the present disclosure.

### Additional Comments

The foregoing embodiments disclose the following techniques.

<Technique 1> A power conversion device includes: a first switch provided on a first path connecting a first input/output terminal and a second input/output terminal; a second switch provided on the first path and connected in series with the first switch; a first inductor provided on a second path connecting a third input/output terminal and a connecting node located between the first switch and the second switch on the first path; a first current sensor circuit that detects an electric current flowing to the first inductor; and a first resonant period detection circuit that detects a resonant period of a first resonance phenomenon based on parasitic capacitance of the first switch and the second switch and inductance of the first inductor, the first resonance phenomenon occurring by switching operations of the first switch and the second switch. Energy accumulates in the first inductor in a first energy application period in which the second switch is OFF and the first switch is ON. The first resonance phenomenon occurs due to the energy that has accumulated in the first inductor in the first energy application period. The first resonant period detection circuit detects the resonant period of the first resonance phenomenon based on a result of comparison between a reference voltage and a voltage generated from a resonance current flowing to the first inductor due to the first resonance phenomenon and detected by the first current sensor circuit.

The resonant period required for zero voltage switching of the first switch and the second switch is detected on the basis of the resonance current flowing to the first inductor instead of the voltage at each end of the first inductor. Specifically, by detecting the direction of the resonance current flowing to the first inductor, it is possible to detect the resonant period, meaning that a single current sensor circuit will suffice and the circuit size can be reduced. Furthermore, there are cases where the current sensor circuit has already been provided for the operation in the CRM and in such cases, the resonant period can be detected using the current sensor circuit that has already been provided and therefore, the increase in circuit size can be minimized. Moreover, since a resonance current which varies more gradually than a resonance voltage is used in the detection of the resonant period, it is less likely that noise will be superimposed during the detection of the resonant period. Thus, the power conversion device according to the present disclosure is capable of reducing noise and can be reduced in size.

<Technique 2> The power conversion device according to technique 1 further includes: a third switch provided on a third path different from the first path and connecting the first input/output terminal and the second input/output terminal; a fourth switch provided on the third path and connected in series with the third switch; and a second inductor provided on a fourth path connecting the third input/output terminal and a connecting node located between the third switch and the fourth switch on the third path. The first inductor and the second inductor are magnetically coupled together. The first resonance phenomenon is a resonance phenomenon that occurs by switching operations of the first switch, the second switch, the third switch, and the fourth switch and is based on the parasitic capacitance of the first switch and the second switch and self-inductance and mutual inductance of the first inductor coupled to the second inductor.

Configuring the power conversion device as a two-phase converter and magnetically coupling the first inductor and the second inductor together allows for a quicker response to load variations (specifically, variations in the electric current flowing to a load). Furthermore, when the first inductor and the second inductor are magnetically coupled together, some parts of the first inductor and the second inductor can be shared, meaning that the overall size of the first inductors and the second inductor can be reduced.

<Technique 3> In the power conversion device according to technique 2, the first resonant period detection circuit detects the resonant period of the first resonance phenomenon in a first resonant period detection period, and in the first resonant period detection period, the first switch and the second switch are OFF, one of the third switch or the fourth switch is ON, and the other of the third switch and the fourth switch is OFF.

The resonant period of the first resonance phenomenon changes according to the effective inductance of the first inductor coupled to the second inductor, and the effective inductance of the first inductor changes according to the ON/OFF state of the first switch, the second switch, the third switch, and the fourth switch. Since the resonant period of the first resonance phenomenon is detected in order to adjust the deadtime of the first switch and the second switch, it is necessary to detect the resonant period of the first resonance phenomenon while the ON/OFF state of the first switch, the second switch, the third switch, and the fourth switch is the same as the ON/OFF state of the switches during the deadtime of the first switch and the second switch. The ON/OFF state of the switches during the deadtime of the first switch and the second switch is a state where the first switch and the second switch are OFF, one of the third switch and the fourth switch is ON, and the other of the third switch and the fourth switch is OFF. Therefore, by detecting the resonant period of the first resonance phenomenon when the ON/OFF state of the switches is this state, it is possible to accurately detect the resonant period required for zero voltage switching of the first switch and the second switch even when the first inductor and the second inductor are coupled together.

<Technique 4> In the power conversion device according to technique 3, the first resonant period detection period is an ON time of the one of the third switch or the fourth switch that is ON for a greater amount of time when electric power is transferred to the third input/output terminal by using the third switch, the fourth switch, and the second inductor.

When the first resonant period detection period is set to the ON time of one of the third switch and the fourth switch that is ON for a greater amount of time, the period for detecting the resonant period of the first resonance phenomenon can be increased and therefore, the resonant period required for zero voltage switching of the first switch and the second switch can be detected accurately.

<Technique 5> In the power conversion device according to technique 3 or 4, the first energy application period is set to cause the resonance current flowing to the first inductor, in at least one period, due to the first resonance phenomenon to be included in the first resonant period detection period.

By setting the first energy application period so that the resonance current in at least one period is included in the first resonant period detection period, it is possible to detect the resonant period required for zero voltage switching of the first switch and the second switch in the first resonant period detection period.

<Technique 6> In the power conversion device according to technique 5, the first energy application period is set to cause the resonance current flowing to the first inductor, in an initial one period, due to the first resonance phenomenon to be included in the first resonant period detection period.

Since the resonance current in the initial one period is barely attenuated, by setting the first energy application period so that the resonance current in the initial one period is included in the first resonant period detection period, it is possible to accurately detect the resonant period required for zero voltage switching of the first switch and the second switch in the first resonant period detection period.

<Technique 7> In the power conversion device according to any one of techniques 1 to 6, the first current sensor circuit is configured to, at a timing of switching between positive and negative values of the resonance current flowing to the first inductor due to the first resonance phenomenon, cause switching of a magnitude relation of a voltage generated from the resonance current with respect to the reference voltage.

When the first current sensor circuit is configured so that the timing of switching between the positive and negative values of the resonance current flowing to the first inductor and the timing of switching of the magnitude relation of the voltage generated from the resonance current with respect to the reference voltage match each other, it is possible to easily detect the resonant period required for zero voltage switching of the first switch and the second switch only by detecting the timing of switching of the magnitude relation of the voltage generated from the resonance current with respect to the reference voltage.

<Technique 8> In the power conversion device according to any one of techniques 1 to 7, the first resonant period detection circuit detects the resonant period of the first resonance phenomenon by using an amount of time from first switching to next switching between positive and negative values of the resonance current flowing to the first inductor due to the first resonance phenomenon.

When the amount of time from the first switching to the next switching between the positive and negative values of the resonance current flowing to the first inductor, in other words, the first half period, is detected, the resonant period required for zero voltage switching of the first switch and the second switch can be easily detected. Furthermore, since the resonant period is detected while the first resonance phenomenon is barely attenuated, the resonant period required for zero voltage switching of the first switch and the second switch can be detected accurately.

<Technique 9> The power conversion device according to any one of techniques 1 to 8 further includes: a first correction circuit that performs a first correction of a set value for zero voltage switching of the first switch and the second switch by using the resonant period of the first resonance phenomenon detected by the first resonant period detection circuit.

It is possible to correct the set value for zero voltage switching of the first switch and the second switch, specifically, the set value for adjusting the deadtime of the first switch and the second switch.

<Technique 10> In the power conversion device according to technique 9, the first correction circuit performs the first correction again when a voltage between the first input/output terminal and the second input/output terminal has changed from a voltage between the first input/output terminal and the second input/output terminal obtained the last time the first correction was performed, by at least a predetermined percentage of the voltage, or when an effective value of the electric current flowing to the first inductor has changed from an effective value of the electric current flowing to the first inductor the last time the first correction was performed, by at least a predetermined percentage of the effective value.

The parasitic capacitance of the first switch and the second switch changes according to the voltage between the first input/output terminal and the second input/output terminal and therefore, when the first correction is performed every time said voltage has changed to some degree, the deadtime of the first switch and the second switch can be maintained at an optimum level. Alternatively, since the inductance of the first inductor changes according to the effective value of the electric current flowing to the first inductor, when the first correction is performed every time said effective value has changed to some degree, the deadtime of the first switch and the second switch can be maintained at an optimum level.

<Technique 11> The power conversion device according to technique 2 further includes: a second current sensor circuit that detects an electric current flowing to the second inductor; and a second resonant period detection circuit that detects a resonant period of a second resonance phenomenon that occurs by switching operations of the first switch, the second switch, the third switch, and the fourth switch and is based on parasitic capacitance of the third switch and the fourth switch and self-inductance and mutual inductance of the second inductor coupled to the first inductor. Energy accumulates in the second inductor in a second energy application period in which the fourth switch is OFF and the third switch is ON. The second resonance phenomenon occurs due to the energy that has accumulated in the second inductor in the second energy application period. The second resonant period detection circuit detects the resonant period of the second resonance phenomenon based on a result of comparison between the reference voltage and a voltage generated from a resonance current flowing to the second inductor due to the second resonance phenomenon and detected by the second current sensor circuit.

The resonant period required for zero voltage switching of the third switch and the fourth switch can also be detected on the basis of the resonance current flowing to the second inductor. For example, the deadtime for zero voltage switching of the third switch and the fourth switch can be adjusted while electric power is transferred to the third input/output terminal by using the first switch, the second switch, and the first inductor, or the deadtime for zero voltage switching of the first switch and the second switch can be adjusted while electric power is transferred to the third input/output terminal by using the third switch, the fourth switch, and the second inductor.

<Technique 12> In the power conversion device according to technique 11, the first resonant period detection circuit detects the resonant period of the first resonance phenomenon in a first resonant period detection period, in the first resonant period detection period, the first switch and the second switch are OFF, one of the third switch or the fourth switch is ON, and the other of the third switch and the fourth switch is OFF, the second resonant period detection circuit detects the resonant period of the second resonance phenomenon in a second resonant period detection period, and in the second resonant period detection period, the third switch and the fourth switch are OFF, one of the first switch or the second switch is ON, and the other of the first switch and the second switch is OFF.

The resonant period of the first resonance phenomenon changes according to the effective inductance of the first inductor coupled to the second inductor, and the effective inductance of the first inductor changes according to the ON/OFF state of the first switch, the second switch, the third switch, and the fourth switch. Since the resonant period of the first resonance phenomenon is detected in order to adjust the deadtime of the first switch and the second switch, it is necessary to detect the resonant period of the first resonance phenomenon while the ON/OFF state of the first switch, the second switch, the third switch, and the fourth switch is the same as the ON/OFF state of the switches during the deadtime of the first switch and the second switch. The ON/OFF state of the switches during the deadtime of the first switch and the second switch is a state where the first switch and the second switch are OFF, one of the third switch and the fourth switch is ON, and the other of the third switch and the fourth switch is OFF. Therefore, by detecting the resonant period of the first resonance phenomenon when the ON/OFF state of the switches is this state, it is possible to accurately detect the resonant period required for zero voltage switching of the first switch and the second switch even when the first inductor and the second inductor are coupled together.

The resonant period of the second resonance phenomenon changes according to the effective inductance of the second inductor coupled to the first inductor, and the effective inductance of the second inductor changes according to the ON/OFF state of the first switch, the second switch, the third switch, and the fourth switch. Since the resonant period of the second resonance phenomenon is detected in order to adjust the deadtime of the third switch and the fourth switch, it is necessary to detect the resonant period of the second resonance phenomenon while the ON/OFF state of the first switch, the second switch, the third switch, and the fourth switch is the same as the ON/OFF state of the switches during the deadtime of the third switch and the fourth switch. The ON/OFF state of the switches during the deadtime of the third switch and the fourth switch is a state where the third switch and the fourth switch are OFF, one of the first switch and the second switch is ON, and the other of the first switch and the second switch is OFF. Therefore, by detecting the resonant period of the second resonance phenomenon when the ON/OFF state of the switches is this state, it is possible to accurately detect the resonant period required for zero voltage switching of the third switch and the fourth switch even when the first inductor and the second inductor are coupled together.

<Technique 13> In the power conversion device according to technique 12, the first resonant period detection period is an ON time of the one of the third switch or the fourth switch that is ON for a greater amount of time when electric power is transferred to the third input/output terminal by using the third switch, the fourth switch, and the second inductor, and the second resonant period detection period is an ON time of the one of the first switch or the second switch that is ON for a greater amount of time when electric power is transferred to the third input/output terminal by using the first switch, the second switch, and the first inductor.

When the first resonant period detection period is set to the ON time of one of the third switch and the fourth switch that is ON for a greater amount of time, the period for detecting the resonant period of the first resonance phenomenon can be increased and therefore, the resonant period required for zero voltage switching of the first switch and the second switch can be detected accurately.

Furthermore, when the second resonant period detection period is set to the ON time of one of the first switch and the second switch that is ON for a greater amount of time, the period for detecting the resonant period of the second resonance phenomenon can be increased and therefore, the resonant period required for zero voltage switching of the third switch and the fourth switch can be detected accurately.

<Technique 14> In the power conversion device according to technique 12 or 13, the first energy application period is set to cause the resonance current flowing to the first inductor, in at least one period, due to the first resonance phenomenon to be included in the first resonant period detection period, and the second energy application period is set to cause the resonance current flowing to the second inductor, in at least one period, due to the second resonance phenomenon to be included in the second resonant period detection period.

By setting the first energy application period so that the resonance current in at least one period is included in the first resonant period detection period, it is possible to detect the resonant period required for zero voltage switching of the first switch and the second switch in the first resonant period detection period.

Furthermore, by setting the second energy application period so that the resonance current in at least one period is included in the second resonant period detection period, it is possible to detect the resonant period required for zero voltage switching of the third switch and the fourth switch in the second resonant period detection period.

<Technique 15> In the power conversion device according to technique 14, the first energy application period is set to cause the resonance current flowing to the first inductor, in an initial one period, due to the first resonance phenomenon to be included in the first resonant period detection period, and the second energy application period is set to cause the resonance current flowing to the second inductor, in an initial one period, due to the second resonance phenomenon to be included in the second resonant period detection period.

Since the resonance current in the initial one period is barely attenuated, by setting the first energy application period so that the resonance current in the initial one period is included in the first resonant period detection period, it is possible to accurately detect the resonant period required for zero voltage switching of the first switch and the second switch in the first resonant period detection period.

Furthermore, since the resonance current in the initial one period is barely attenuated, by setting the second energy application period so that the resonance current in the initial one period is included in the second resonant period detection period, it is possible to accurately detect the resonant period required for zero voltage switching of the third switch and the fourth switch in the second resonant period detection period.

<Technique 16> In the power conversion device according to any one of techniques 11 to 15, the first current sensor circuit is configured to, at a timing of switching between positive and negative values of the resonance current flowing to the first inductor due to the first resonance phenomenon, cause switching of a magnitude relation of a voltage generated from the resonance current with respect to the reference voltage, and the second current sensor circuit is configured to, at a timing of switching between positive and negative values of the resonance current flowing to the second inductor due to the second resonance phenomenon, cause switching of a magnitude relation of a voltage generated from the resonance current with respect to the reference voltage.

When the first current sensor circuit is configured so that the timing of switching between the positive and negative values of the resonance current flowing to the first inductor and the timing of switching of the magnitude relation of the voltage generated from the resonance current with respect to the reference voltage match each other, it is possible to easily detect the resonant period required for zero voltage switching of the first switch and the second switch only by detecting the timing of switching of the magnitude relation of the voltage generated from the resonance current with respect to the reference voltage.

Furthermore, when the second current sensor circuit is configured so that the timing of switching between the positive and negative values of the resonance current flowing to the second inductor and the timing of switching of the magnitude relation of the voltage generated from the resonance current with respect to the reference voltage match each other, it is possible to easily detect the resonant period required for zero voltage switching of the third switch and the fourth switch only by detecting the timing of switching of the magnitude relation of the voltage generated from the resonance current with respect to the reference voltage.

<Technique 17> In the power conversion device according to any one of techniques 11 to 16, the first resonant period detection circuit detects the resonant period of the first resonance phenomenon by using an amount of time from first switching to next switching between positive and negative values of the resonance current flowing to the first inductor due to the first resonance phenomenon, and the second resonant period detection circuit detects the resonant period of the second resonance phenomenon by using an amount of time from first switching to next switching between positive and negative values of the resonance current flowing to the second inductor due to the second resonance phenomenon.

When the amount of time from the first switching to the next switching between the positive and negative values of the resonance current flowing to the first inductor, in other words, the first half period, is detected, the resonant period required for zero voltage switching of the first switch and the second switch can be easily detected. Furthermore, since the resonant period is detected while the first resonance phenomenon is barely attenuated, the resonant period required for zero voltage switching of the first switch and the second switch can be detected accurately.

Furthermore, when the amount of time from the first switching to the next switching between the positive and negative values of the resonance current flowing to the second inductor, in other words, the first half period, is detected, the resonant period required for zero voltage switching of the third switch and the fourth switch can be easily detected. Furthermore, since the resonant period is detected while the second resonance phenomenon is barely attenuated, the resonant period required for zero voltage switching of the third switch and the fourth switch can be detected accurately.

<Technique 18> The power conversion device according to any one of techniques 11 to 17 further includes: a first correction circuit that performs a first correction of a set value for zero voltage switching of the first switch and the second switch by using the resonant period of the first resonance phenomenon detected by the first resonant period detection circuit; and a second correction circuit that performs a second correction of a set value for zero voltage switching of the third switch and the fourth switch by using the resonant period of the second resonance phenomenon detected by the second resonant period detection circuit.

It is possible to correct the set value for zero voltage switching of the first switch and the second switch, specifically, the set value for adjusting the deadtime of the first switch and the second switch.

Furthermore, it is possible to correct the set value for zero voltage switching of the third switch and the fourth switch, specifically, the set value for adjusting the deadtime of the third switch and the fourth switch.

<Technique 19> In the power conversion device according to technique 18, the first correction circuit performs the first correction again when a voltage between the first input/output terminal and the second input/output terminal has changed from a voltage between the first input/output terminal and the second input/output terminal obtained the last time the first correction was performed, by at least a predetermined percentage, or when an effective value of the electric current flowing to the first inductor has changed from an effective value of the electric current flowing to the first inductor the last time the first correction was performed, by at least a predetermined percentage, and the second correction circuit performs the second correction again when a voltage between the first input/output terminal and the second input/output terminal has changed from a voltage between the first input/output terminal and the second input/output terminal obtained the last time the second correction was performed, by at least a predetermined percentage, or when an effective value of the electric current flowing to the second inductor has changed from an effective value of the electric current flowing to the second inductor the last time the second correction was performed, by at least a predetermined value.

The parasitic capacitance of the first switch and the second switch changes according to the voltage between the first input/output terminal and the second input/output terminal and therefore, when the first correction is performed every time said voltage has changed to some degree, the deadtime of the first switch and the second switch can be maintained at an optimum level. Alternatively, since the inductance of the first inductor changes according to the effective value of the electric current flowing to the first inductor, when the first correction is performed every time said effective value has changed to some degree, the deadtime of the first switch and the second switch can be maintained at an optimum level.

Furthermore, the parasitic capacitance of the third switch and the fourth switch changes according to the voltage between the first input/output terminal and the second input/output terminal and therefore, when the second correction is performed every time said voltage has changed to some degree, the deadtime of the third switch and the fourth switch can be maintained at an optimum level. Alternatively, since the inductance of the second inductor changes according to the effective value of the electric current flowing to the second inductor, when the second correction is performed every time said effective value has changed to some degree, the deadtime of the third switch and the fourth switch can be maintained at an optimum level.

### INDUSTRIAL APPLICABILITY

The present disclosure is applicable to a step-up converter or a step-down converter that performs zero voltage switching.

### REFERENCE SIGNS LIST

1, 2, 3 power conversion device
11, 12 current sensor circuit
21, 22 resonant period detection circuit
31, 32 correction circuit
C1, C2 parasitic capacitance
L1, L2 inductor
N1, N2 connecting node
P1, P2, P3, P4 path
SW1, SW2, SW3, SW4 switch
t1, t2, t3 input/output terminal

1. A power conversion device comprising:
a first switch provided on a first path connecting a first input/output terminal and a second input/output terminal;
a second switch provided on the first path and connected in series with the first switch;
a first inductor provided on a second path connecting a third input/output terminal and a connecting node located between the first switch and the second switch on the first path;
a first current sensor circuit that detects an electric current flowing to the first inductor; and
a first resonant period detection circuit that detects a resonant period of a first resonance phenomenon based on parasitic capacitance of the first switch and the second switch and inductance of the first inductor, the first resonance phenomenon occurring by switching operations of the first switch and the second switch, wherein
energy accumulates in the first inductor in a first energy application period in which the second switch is OFF and the first switch is ON,
the first resonance phenomenon occurs due to the energy that has accumulated in the first inductor in the first energy application period, and
the first resonant period detection circuit detects the resonant period of the first resonance phenomenon based on a result of comparison between a reference voltage and a voltage generated from a resonance current flowing to the first inductor due to the first resonance phenomenon and detected by the first current sensor circuit.

2. The power conversion device according to claim 1, further comprising:
a third switch provided on a third path different from the first path and connecting the first input/output terminal and the second input/output terminal;
a fourth switch provided on the third path and connected in series with the third switch; and
a second inductor provided on a fourth path connecting the third input/output terminal and a connecting node located between the third switch and the fourth switch on the third path, wherein
the first inductor and the second inductor are magnetically coupled together, and
the first resonance phenomenon is a resonance phenomenon that occurs by switching operations of the first switch, the second switch, the third switch, and the fourth switch and is based on the parasitic capacitance of the first switch and the second switch and self-inductance and mutual inductance of the first inductor coupled to the second inductor.

3. The power conversion device according to claim 2, wherein
the first resonant period detection circuit detects the resonant period of the first resonance phenomenon in a first resonant period detection period, and
in the first resonant period detection period, the first switch and the second switch are OFF, one of the third switch or the fourth switch is ON, and an other of the third switch and the fourth switch is OFF.

4. The power conversion device according to claim 3, wherein
the first resonant period detection period is an ON time of the one of the third switch or the fourth switch that is ON for a greater amount of time when electric power is transferred to the third input/output terminal by using the third switch, the fourth switch, and the second inductor.

5. The power conversion device according to claim 3, wherein
the first energy application period is set to cause the resonance current flowing to the first inductor, in at least one period, due to the first resonance phenomenon to be included in the first resonant period detection period.

6. The power conversion device according to claim 5, wherein
the first energy application period is set to cause the resonance current flowing to the first inductor, in an initial one period, due to the first resonance phenomenon to be included in the first resonant period detection period.

7. The power conversion device according to claim 1, wherein
the first current sensor circuit is configured to, at a timing of switching between positive and negative values of the resonance current flowing to the first inductor due to the first resonance phenomenon, cause switching of a magnitude relation of a voltage generated from the resonance current with respect to the reference voltage.

8. The power conversion device according to claim 1, wherein
the first resonant period detection circuit detects the resonant period of the first resonance phenomenon by using an amount of time from first switching to next switching between positive and negative values of the resonance current flowing to the first inductor due to the first resonance phenomenon.

9. The power conversion device according to claim 1, further comprising:
a first correction circuit that performs a first correction of a set value for zero voltage switching of the first switch and the second switch by using the resonant period of the first resonance phenomenon detected by the first resonant period detection circuit.

10. The power conversion device according to claim 9, wherein
the first correction circuit performs the first correction again when a voltage between the first input/output terminal and the second input/output terminal has changed from a voltage between the first input/output terminal and the second input/output terminal obtained a last time the first correction was performed, by at least a predetermined percentage of the voltage, or when an effective value of the electric current flowing to the first inductor has changed from an effective value of the electric current flowing to the first inductor the last time the first correction was performed, by at least a predetermined percentage of the effective value.

11. The power conversion device according to claim 2, further comprising:
a second current sensor circuit that detects an electric current flowing to the second inductor; and
a second resonant period detection circuit that detects a resonant period of a second resonance phenomenon that occurs by switching operations of the first switch, the second switch, the third switch, and the fourth switch and is based on parasitic capacitance of the third switch and the fourth switch and self-inductance and mutual inductance of the second inductor coupled to the first inductor, wherein
energy accumulates in the second inductor in a second energy application period in which the fourth switch is OFF and the third switch is ON,
the second resonance phenomenon occurs due to the energy that has accumulated in the second inductor in the second energy application period, and
the second resonant period detection circuit detects the resonant period of the second resonance phenomenon based on a result of comparison between the reference voltage and a voltage generated from a resonance current flowing to the second inductor due to the second resonance phenomenon and detected by the second current sensor circuit.

12. The power conversion device according to claim 11, wherein
the first resonant period detection circuit detects the resonant period of the first resonance phenomenon in a first resonant period detection period,
in the first resonant period detection period, the first switch and the second switch are OFF, one of the third switch or the fourth switch is ON, and an other of the third switch and the fourth switch is OFF,
the second resonant period detection circuit detects the resonant period of the second resonance phenomenon in a second resonant period detection period, and
in the second resonant period detection period, the third switch and the fourth switch are OFF, one of the first switch or the second switch is ON, and an other of the first switch and the second switch is OFF.

13. The power conversion device according to claim 12, wherein
the first resonant period detection period is an ON time of the one of the third switch or the fourth switch that is ON for a greater amount of time when electric power is transferred to the third input/output terminal by using the third switch, the fourth switch, and the second inductor, and
the second resonant period detection period is an ON time of the one of the first switch or the second switch that is ON for a greater amount of time when electric power is transferred to the third input/output terminal by using the first switch, the second switch, and the first inductor.

14. The power conversion device according to claim 12, wherein
the first energy application period is set to cause the resonance current flowing to the first inductor, in at least one period, due to the first resonance phenomenon to be included in the first resonant period detection period, and
the second energy application period is set to cause the resonance current flowing to the second inductor, in at least one period, due to the second resonance phenomenon to be included in the second resonant period detection period.

15. The power conversion device according to claim 14, wherein
the first energy application period is set to cause the resonance current flowing to the first inductor, in an initial one period, due to the first resonance phenomenon to be included in the first resonant period detection period, and
the second energy application period is set to cause the resonance current flowing to the second inductor, in an initial one period, due to the second resonance phenomenon to be included in the second resonant period detection period.

16. The power conversion device according to claim 11, wherein
the first current sensor circuit is configured to, at a timing of switching between positive and negative values of the resonance current flowing to the first inductor due to the first resonance phenomenon, cause switching of a magnitude relation of a voltage generated from the resonance current with respect to the reference voltage, and
the second current sensor circuit is configured to, at a timing of switching between positive and negative values of the resonance current flowing to the second inductor due to the second resonance phenomenon, cause switching of a magnitude relation of a voltage generated from the resonance current with respect to the reference voltage.

17. The power conversion device according to claim 11, wherein
the first resonant period detection circuit detects the resonant period of the first resonance phenomenon by using an amount of time from first switching to next switching between positive and negative values of the resonance current flowing to the first inductor due to the first resonance phenomenon, and
the second resonant period detection circuit detects the resonant period of the second resonance phenomenon by using an amount of time from first switching to next switching between positive and negative values of the resonance current flowing to the second inductor due to the second resonance phenomenon.

18. The power conversion device according to claim 11, further comprising:
a first correction circuit that performs a first correction of a set value for zero voltage switching of the first switch and the second switch by using the resonant period of the first resonance phenomenon detected by the first resonant period detection circuit; and
a second correction circuit that performs a second correction of a set value for zero voltage switching of the third switch and the fourth switch by using the resonant period of the second resonance phenomenon detected by the second resonant period detection circuit.

19. The power conversion device according to claim 18, wherein
the first correction circuit performs the first correction again when a voltage between the first input/output terminal and the second input/output terminal has changed from a voltage between the first input/output terminal and the second input/output terminal obtained a last time the first correction was performed, by at least a predetermined percentage, or when an effective value of the electric current flowing to the first inductor has changed from an effective value of the electric current flowing to the first inductor the last time the first correction was performed, by at least a predetermined percentage, and
the second correction circuit performs the second correction again when a voltage between the first input/output terminal and the second input/output terminal has changed from a voltage between the first input/output terminal and the second input/output terminal obtained a last time the second correction was performed, by at least a predetermined percentage, or when an effective value of the electric current flowing to the second inductor has changed from an effective value of the electric current flowing to the second inductor the last time the second correction was performed, by at least a predetermined value.
